(19) United States
(12) Patent Application Publication
(10) Pub. No.: US 2005/0212933 A1
(43) Pub. Date: Sep. 29, 2005

(54) Luminance and color difference signal generation apparatus, image data compression apparatus, and image processing system

(75) Inventor: Makoto Miyanohara, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 11/083,925

(22) Filed: Mar. 21, 2005

(30) Foreign Application Priority Data
Mar. 26, 2004 (JP) 2004-091389

(51) Int. Cl. H04N 5/21

(52) U.S. Cl. 348/272

(57) ABSTRACT

A luminance and color difference signal generation apparatus uses a color signal outputted from a solid-state image sensing device to which a color filter having a predetermined color arrangement is attached. An interpolator generates the color signal of interpolated color signals different from the color attribute of the color filter associated with objective pixels by interpolation. A luminance and color difference signal generator generates at least one signal of the luminance signal and one or more color difference signals concerning the objective pixel. An objective pixel indicator indicates the pixel for which the luminance signal and the color difference signals are to be generated.

### BACKGROUND OF THE INVENTION

1. Field of the Invention

The present invention relates to a luminance and color difference signal generation apparatus which carries out generation of a luminance signal and a color difference signal from a color signal, an image data compression apparatus which carries out compression of the luminance and color difference signals generated from the color signal, and an image processing system which performs compression, decompression (or expansion) and reproduction of the luminance and color difference signals generated from the color signal. In particular, the present invention relates to a luminance and color difference signal generation apparatus, an image data compression apparatus and an image processing system applicable and suitable for various products in which electric power conservation and miniaturization in size are comparatively demanded rather than quality of image, such as a capsule-type endoscope or a cellular phone.

Priority is claimed on Japanese Patent Application No. 2004-91389, filed Mar. 26, 2004, the content of which is incorporated herein by reference.

2. Description of Related Art

In a general image processing system as shown in FIG. 12, an imaging device 101 has a solid-state image sensor which receives reflection light from an object and outputs a color signal in response to an amount of light received from the object. The color signal from the solid-state image sensor is outputted as image data. In order to effect efficient transmission or storage of the image data, the image data is compressed by an image data compression apparatus 102 in order to be transmitted or stored. The image data compression apparatus 102 performs compression processing according to standards for image compression, such as JPEG (Joint Photographic Expert Group) and MPEG (Moving Picture Expert Group), on the image data inputted thereto.

When using a single solid-state image sensor, a conventional imaging device carries out the following process in order to reduce the degradation of the image data due to the compression processing of the image data by the image data compression apparatus 102. First, the initial color signals obtained by the image sensor are subjected to interpolation processing so as to be converted into color signals R (red), G (green) and B (blue) whose total number is 3 times the number of the initial color signals. The color signals R, G and B are then subjected to color space conversion processing and converted into a luminance signal Y and color difference signals U and V to be inputted to the image data compression apparatus 102.

An image data expansion apparatus 103 receives the transmitted image data which was subjected to compression processing and performs decompression processing on the transmitted image according to the compression standard. An image reproducing apparatus 104 performs the inverse operation of the color space conversion processing on the luminance signal Y and the color difference signals U and V acquired from the image data expansion apparatus 103 and converts these signals into the color signals R, G and B to display them as a picture.

Hereafter, the image processing system which includes the imaging device 101, image data compression apparatus 102, image data expansion apparatus 103, and image reproducing apparatus 104 will be explained in detail in reference to FIG. 13.

The pre-processing unit 201 of the imaging device 101 is equipped with a color filter 2011, a solid-state image sensing device 2012, an interpolator 2013, and a luminance and color difference signal generator 2014 as shown in FIG. 13. The color filter 2011 has a Bayer pattern in which a mosaic or grid of color filters of R, G and B is arranged, and is attached to and placed on the face of the solid-state image sensing device 2012. The light from the object enters the solid-state image sensing device 2012 through the color filter 2011.

The solid-state image sensing device 2012 is equipped with a plurality of optical sensing elements (pixels) corresponding to each color filter of the color filter 2011. This solid-state image sensing device 2012 receives the light from the object through the color filter 2011 and outputs the color signal according to the amount of the light received thereby. The output from the solid-state image sensing device 2012 is inputted into the interpolation processor 2013 as the color signal.

Based on the color signal outputted from the solid-state image sensing device 2012, the interpolation processor 2013 performs interpolation processing for every pixel, and generates color signals R, G and B. These color signals R, G and B are inputted into the luminance and color difference signal generator 2014. The luminance and color difference signal generator 2014 generates a luminance signal Y and color difference signals U and V based on the color signals R, G and B outputted from the interpolation processor 2013. The luminance signal Y and the color difference signals U and V are inputted into an image data compression unit 202 as image data.

The image data compression unit 202 includes a frequency converter 2021, a quantizer 2022, and an encoder 2023. The frequency converter 2021 computes spatial frequency components in the luminance signal Y and the color difference signals U and V in a predetermined block. In the JPEG standard, for example, 1 block consists of 8 horizontal signals and 8 vertical signals (signals for 8 columns and 8 rows), i.e., 8×8 signals, for each of the luminance signal Y and the color difference signals U and V. DCT (Discrete Cosine Transform) which is one kind of orthogonal transformation is carried out for each block (8×8 signals) as a unit, and they are changed into the spatial frequency components. The spatial frequency components are then inputted into the quantizer 2022.

The quantizer 2022 quantizes the spatial frequency components outputted from the frequency converter 2021. Quantized spatial frequency components which are outputted from the quantizer 2022 are inputted into the encoder 2023. The encoder 2023 makes code data in response to the quantized spatial frequency components which are outputted from the quantizer 2022. For example, according to the JPEG standard, run length coding and Huffman code processing are performed on the quantized spatial frequency components which are outputted from the quantizer 2022. The code data is inputted into an image data expansion unit 203.

The image data expansion unit 203 includes a decoder 2031, a reverse quantizer 2032, and a reverse frequency converter 2033. The image data expansion unit 203 performs decompression processing corresponding to the compression processing performed to reconstruct the code data compressed by the image data compression unit 202, and outputs the luminance signal Y and the color difference signals U and V. For example, according to the JPEG standard, Huffman decode processing, run length decoding, reverse quantization, and reverse DCT are carried out. The luminance signal Y and the color difference signals U and V outputted from the image data expansion unit 203 are inputted into a post-processing unit 204.

The post-processing unit 204 is equipped with a color signal generator 2041. The color signal generator 2041 generates the color signals R, G and B based on the luminance signal Y and the color difference signals U and V outputted from the image data expansion unit 203.

Thus, the conventional image processing system generates the color signals R, G and B from the color signal acquired from the solid-state image sensing device by interpolation processing for every pixel, and then, generates the luminance signal Y and the color difference signals U and V by the color space conversion processing based on the color signals R, G and B.

In relation to such image signal processing, Japanese Provisional Patent Publication No. H4-284087 discloses the processing manner of an image signal outputted from an image sensor of a single plate. According to this processing manner, the color signals R, G and B are outputted from the image sensor equipped with a color filter having a mosaic or grid of color filter elements arranged in a Bayer pattern and separated for every color signal. The separated color signals R, G and B are compressed, after interpolation processing is carried out so that degradation of the image data compression may be decreased.

### SUMMARY OF THE INVENTION

A luminance and color difference signal generation apparatus according to a first aspect of the present invention, which generates luminance and color difference signals based on a plurality of initial color signals outputted from a solid-state image sensing device equipped with a color filter having a plurality of color elements arranged in a predetermined pattern on a photo sensitive surface having a plurality of pixels arranged in a matrix form, comprises: an objective pixel indicator which determines an objective pixel among the plurality of pixels of the solid-state image sensing device: an interpolation processor which generates color signals of the objective pixel according to an interpolation calculation, the color signals being indicative of colors different from a color of the color element of the color filter associated with the objective pixel: a luminance and color difference signal generator which generates the luminance signal and a first color difference signal of the color difference signals based on a color signal obtained from the objective pixel and the color signals obtained by the interpolation calculation concerning the objective pixel.

In the luminance and color difference signal generation apparatus of the first aspect of the present invention, a luminance and color difference signal generation apparatus according to a second aspect of the present invention further has a feature that the objective pixel indicator determines a pixel associated with a green color element of the color filter among the plurality of pixels of the solid-state image sensing device as the objective pixel.

In the luminance and color difference signal generation apparatus of the first aspect of the present invention, a luminance and color difference signal generation apparatus according to a third aspect of the present invention further has a feature that: the color filter has the color elements arranged in a Bayer pattern; the luminance and color difference signal generator generates the luminance signal and a first color difference signal of the color difference signals when the objective pixel is in an odd column in the matrix form of the plurality of pixels; and the luminance and color difference signal generator generates the luminance signal and a second color difference signal different from the first color difference signal when the objective pixel is in an even column in the matrix form of the plurality of pixels.

A luminance and color difference signal generation apparatus according to a fourth aspect of the present invention, which generates a luminance and color difference signals based on a plurality of initial color signals outputted from a solid-state image sensing device equipped with a color filter having a plurality of color elements arranged in a predetermined pattern on a photo sensitive surface having a plurality of pixels arranged in a matrix form, comprises: an objective pixel indicator which determine an objective pixel among the plurality of pixels of the solid-state image sensing device: an interpolation processor which generates color signals of the objective pixel according to an interpolation calculation, the color signals being indicative of colors different from a color of the color element of the color filter associated with the objective pixel: a luminance and color difference signal generator which generates at least one of said luminance and color difference signals according to said color of said color element associated with said objective pixel and based on a color signal obtained from the objective pixel and the color signals obtained by the interpolation calculation concerning the objective pixel.

In the luminance and color difference signal generation apparatus of the fourth aspect of the present invention, a luminance and color difference signal generation apparatus according to a fifth aspect of the present invention further has a feature that the luminance and color difference signal generator generates the luminance signal when the objective pixel is associated with a green color element, generates a first color difference signal of the color difference signals when the objective pixel is associated with a red color element, and generates a second color difference signal different from the first color difference signal of the color difference signals when the objective pixel is associated with a blue color element.

A luminance and color difference signal generation apparatus according to a sixth aspect of the present invention, which generates a luminance signal and color difference signals from a plurality of initial color signals outputted from a solid-state image sensing device equipped with a color filter having a plurality of color elements arranged in a predetermined pattern on a photo sensitive surface having a plurality of pixels arranged in a matrix form, comprises: an interpolation processor which generates color signals of an arbitrary pixel according to an interpolation calculation, the color signals being indicative of color attributes different from a color attribute of the color element of the color filter associated with the arbitrary pixel: a luminance and color difference signal generator which generates at least one of the luminance and color difference signals for the arbitrary pixel based on the color signals concerning the arbitrary pixel; and an objective pixel indicator which determines pixels in a predetermined column or predetermined row in the matrix form of the plurality of pixels of the solid-state image sensing device as objective pixels for which the luminance signal and/or the color difference signals are generated.

In the luminance and color difference signal generation apparatus of the sixth aspect of the present invention, a luminance and color difference signal generation apparatus according to a seventh aspect of the present invention further has a feature that the objective pixel indicator selects the predetermined column or predetermined row according to a certain pattern.

In the luminance and color difference signal generation apparatus of the sixth aspect of the present invention, a luminance and color difference signal generation apparatus according to a eighth aspect of the present invention further has a feature that the luminance and color difference signal generator generates a predetermined combination of the luminance signal and the color difference signals in response to each of the predetermined column or predetermined row.

In the luminance and color difference signal generation apparatus of the sixth aspect of the present invention, a luminance and color difference signal generation apparatus according to a ninth aspect of the present invention further has a feature that: the color filter has the color elements arranged in a Bayer pattern; the luminance and color difference signal generator generates the luminance signal and a first color difference signal of the color difference signals when the predetermined column is an odd column in the matrix form of the plurality of pixels; and the luminance and color difference signal generator generates the luminance signal and a second color difference signal different from the first color difference signals when the predetermined column is an even column in the matrix form of the plurality of pixels; or the luminance and color difference signal generator generate the luminance signal and a first color difference signal of the color difference signals when the predetermined row is an odd row in the matrix form of the plurality of pixels; and the luminance and color difference signal generator generate the luminance signal and a second color difference signal different from the first color difference signal when the predetermined row is an even row in the matrix form of the plurality of pixels.

In the luminance and color difference signal generation apparatus of the first aspect of the present invention, a luminance and color difference signal generation apparatus according to a tenth aspect of the present invention further comprises: additional luminance and color difference signal generators provided for different operations; and a selector which selects one of the luminance and color difference signal generators in response to an operation to be done.

In the luminance and color difference signal generation apparatus of the first aspect of the present invention, a luminance and color difference signal generation apparatus according to a eleventh aspect of the present invention further has a feature that the interpolation processor calculates the color signals indicative of colors different from a color of the color element of the color filter associated with the objective pixel by means of color signals obtained from pixels near the objective pixel.

An image compression apparatus according to twelfth aspect of the present invention comprises the luminance and color difference signal generation apparatus according to the first aspect of the present invention and an image compression unit including: a frequency converter which calculates spatial frequency components for each block in each of the luminance signal and the color difference signal generated by the luminance and color difference signal generation apparatus; a quantizer which quantizes the spatial frequency components; and an encoder which encodes the quantized spatial frequency components quantized by the quantizer.

An image processing system according to a thirteenth aspect of the present invention comprises: the image compression apparatus of the thirteenth aspect of the present invention; an image data expansion unit including a decoder which decodes the quantized spatial frequency components ingredient quantized from the output of the image compression apparatus, a reverse quantizer which performs reverse-quantization of the decoded spatial frequency components, and a reverse frequency converter which calculates the luminance signal and the color difference signals for each of the blocks based on the reverse-quantized spatial frequency components; and a format converter which converts the luminance signal and the color difference signals outputted from the image data expansion unit into an output format required by an external apparatus.

In the image processing system of the thirteenth aspect of the present invention, an image processing system according to a fourteenth aspect of the present invention further has a feature that the format converter further includes: an image signal generator which converts the luminance signal and the color difference signals into the color signals; and a color signal generator which interpolates color signals for pixels other than the objective pixel to the color signals from the image signal generator.

In the image processing system of the thirteenth aspect of the present invention, an image processing system according to a fifteenth aspect of the present invention further has a feature that the format converter further includes: a luminance and color difference signal interpolator which interpolates luminance signal and color difference signal for pixels other than the objective pixel based on the luminance signal and the color difference signal; and a color signal generator which converts the luminance signal and the color difference signal obtained from the luminance and color difference signal interpolator into the color signals.

### BRIEF DESCRIPTION OF THE DRAWINGS

FIG. 1 is a block diagram showing an image processing system according a first embodiment the present invention.

FIGS. 2A and 2B are drawings showing a primary color filter and a complementary color filter which are used for the image processing system according to the first embodiment of the present invention.

FIGS. 3A, 3B and 3C are drawings showing an object of an image data compression performed in the image processing system according to the first embodiment of the present invention.

FIG. 4 is a drawing showing a photo sensitive surface of a solid-state image sensing device used in the image processing system according to the first, a second and a third embodiments of the present invention.

FIG. 5 is a block diagram showing a circuit for calculating values of an objective pixel used in the image processing system according to the first embodiment of the present invention.

FIG. 6 is schematic view showing a complementary color filter used instead of a primary color filter in the image processing system according to the first embodiment of the present invention.

FIGS. 7A, 7B, and 7C are drawings showing an image signal in which interpolation processing was carried out in the image processing system according to the first embodiment of the present invention.

FIG. 8 is a block diagram showing an alternative example of the image processing system according to the first embodiment of the present invention.

FIG. 9 is a block diagram showing an image processing system according to the second embodiment of the present invention.

FIGS. 10A, 10B and 10C are drawings showing an image signal in which interpolation processing was carried out in the image processing system according to the second embodiment of the present invention.

FIG. 11 is a block diagram showing an image processing system according to the third embodiment of the present invention.

FIG. 12 is a block diagram showing an image processing system.

FIG. 13 is a block diagram showing a conventional image processing system.

### DESCRIPTION OF THE PREFERRED EMBODIMENTS

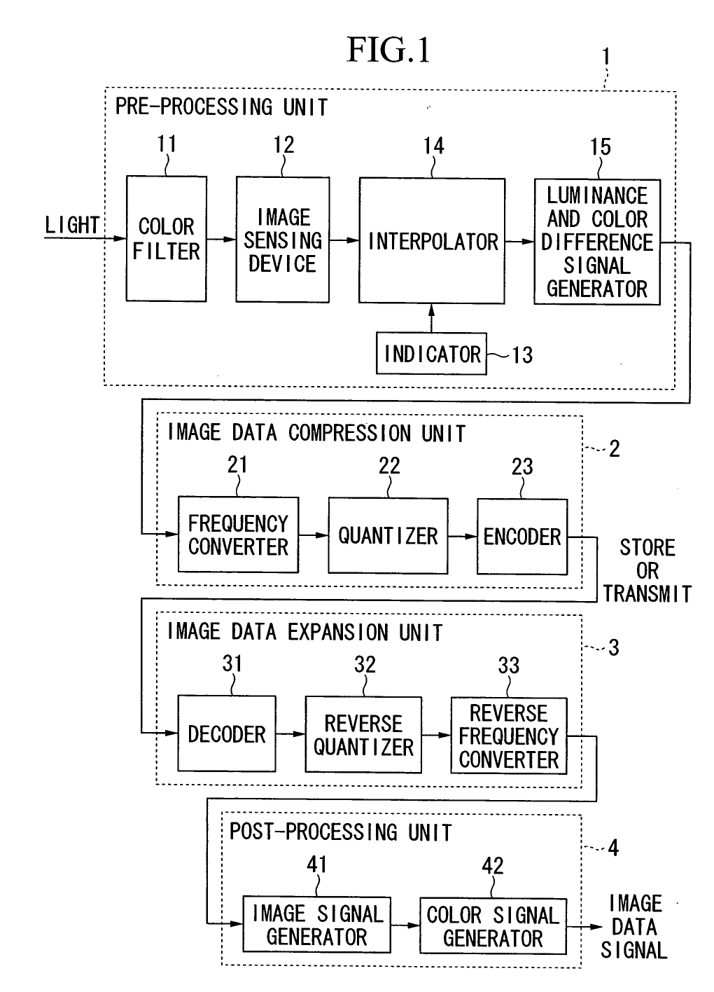

Hereafter, embodiments of the present invention will be described in detail with reference to FIGS. 1 to 11.

### First Embodiment

An image processing system according to a first embodiment of the present invention includes a pre-processing unit 1, an image data compression unit 2, an image data expansion unit 3, and a post-processing unit 4, as shown in FIG. 1.

The pre-processing unit 1 contains a color filter 11, a solid-state image sensing device 12 of a single plate type, an objective pixel indicator 13, an interpolator 14, and a luminance and color difference signal generator 15.

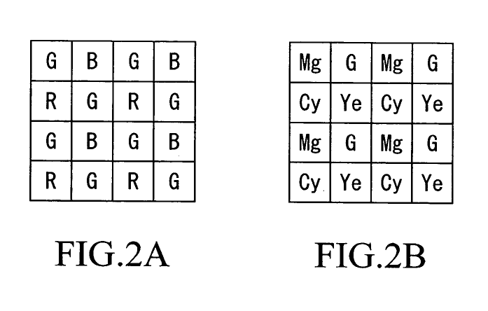

The pre-processing unit 1 receives light from an object and generates a luminance signal Y and color difference signals U and V for the light. The color filter 11 is attached to a photo receiving surface of the solid-state image sensing device 12. As the color filter 11, as shown in FIG. 2A, a primary color filter in which color elements of R (red), G (green) and B (blue) are arranged in mosaic or grid to form Bayer pattern is used, for example. The light from the object thus enters into the solid-state image sensing device 12 through the color filter 11.

Here, the color filter 11 may be a complementary color filter as shown in FIG. 2B.

The solid-state image sensing device 12 is equipped with a plurality of photo receiving elements (pixels) which correspond to the color elements of the color filter 11, and outputs the color signals in response to the amount or quantity of light received by each of the pixels. The indicator 13 chooses an objective pixel for which a luminance signal and color difference signals are to be generated, as described later.

The interpolator 14 generates a color signal of the objective pixel of the sensing device 12 at the position where the objective pixel indicator 13 is indicated. Also, the interpolator 14 generates interpolated color signals which are indicative of colors different from the color of the objective pixel by carrying out interpolation processing on the color signals outputted from the solid-state image sensing device 12. The interpolation processing method will be mentioned later. The luminance and color difference signal generator 15 generate a luminance signal Y and color difference signals U and V from the signal outputted from the interpolator 14. The generation method of the luminance signal Y and the color difference signals U and V will also be described later. The luminance signal Y and the color difference signals U and V are supplied to the image data compression unit 2.

Next, the operation of the image data compression unit 2 and the image data expansion unit 3 is explained.

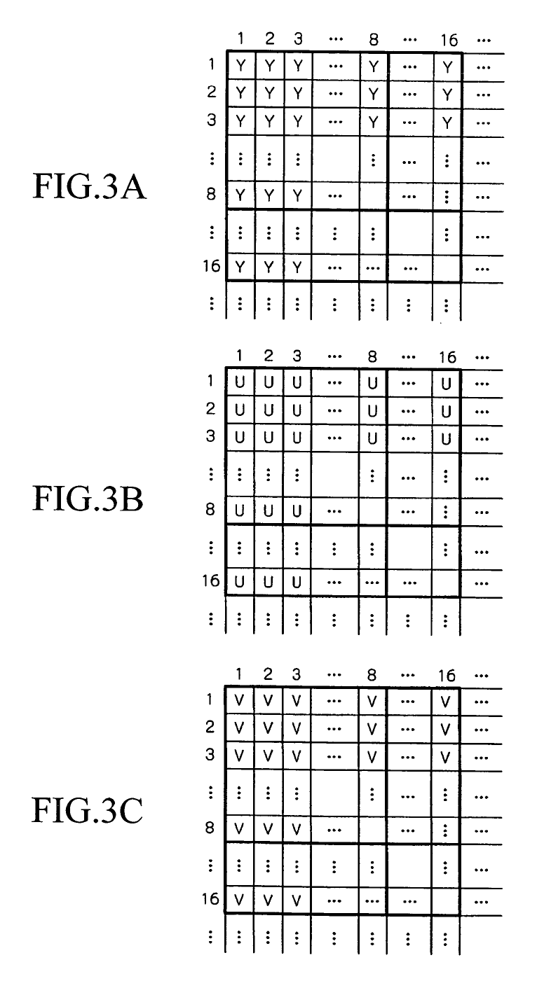

The explanation is made in the case where the image data compression unit 2 and the image data expansion unit 3 employ JPEG standard, as an image-processing CODEC. As shown in FIGS. 3A to 3C, each of the luminance signal Y and the color difference signals V and U are divided as a block consisting of 8 horizontal signals×8 vertical signals (8 columns and 8 rows) as a unit. Compression processing by the image data compression unit 2 is performed for every block as a unit.

The image data compression unit 2 includes a frequency converter 21, a quantizer 22, and an encoder 23. The image data compression unit 2 generates code data for the luminance signal Y and the color difference signals U and V generated by the pre-processing unit 1. The frequency converter 21 performs a discrete cosine transform (DCT), and changes the signals into spatial frequency components. The quantizer 22 quantizes the spatial frequency components outputted from the frequency converter 21.

On the quantized spatial frequency components which are outputted from the quantizer 22, the encoder 23 performs run length coding and Huffman coding to generate code data. The code data thus generated in the image data compression unit 2 is stored in memory etc., or is transmitted to a receiver. In this embodiment, the code data is supplied to the image data expansion unit 3.

The image data expansion unit 3 includes a decoder 31, a reverse quantizer 32 and a reverse frequency converter 33. The image data expansion unit 3 generates the luminance signal Y and the color difference signals U and V in response to the code data compressed by the image data compression unit 2. The decoder 31 performs decoding processing such as the Huffman decoding and run length decoding to the code data. The reverse quantizer 32 performs reverse quantization on the spatial frequency components outputted from the decoder 31.

On the reverse-quantized spatial frequency components which are outputted from the reverse quantizer 32, the reverse frequency converter 33 performs a reverse discrete cosine transform, and generates the luminance signal Y and the color difference signals U and V. The luminance signal Y the color difference signals U and V thus generated in the image data expansion unit 3 are inputted into the post-processing unit 4.

The post-processing unit 4 includes an image signal generator 41 and a color signal generator 42. The post-processing unit 4 generates an image signal represented by the luminance signal Y and the color difference signals U and V which are decompressed by the image data expansion unit 3.

The image signal generator 41 carries out interpolation processing on every luminance signal Y and color difference signals U and V outputted from the image data expansion unit 3, and generates an image signal. The interpolation processing is performed by making it correspond to the operations of the indicator 13, the interpolator 14 and the luminance and color difference signal generator 15 in the pre-processing unit 1. On the image signal outputted from the image signal generator 41, the color difference signal generator 42 performs color space conversion processing, and generates the image signal represented by the color signals R, G and B. The signal processing by the post-processing unit 4 will be described in detail later.

The image signal generated by the post-processing unit 4 as mentioned above is reproduced as a picture with a picture playback apparatus, etc.

Next, the operations of the indicator 13, the interpolator 14 and the luminance and color difference signal generator 15 in the first embodiment are explained in detail.

Generally, the formulas which compute the luminance signal Y and the color difference signals U and V from the color signals R, G and B are expressed by the following formulas (1):
Y=0.30R+0.59G+0.11B
U=0.70R−0.59G−0.11B
V=−0.30R−0.59G+0.89B Formulas (1)

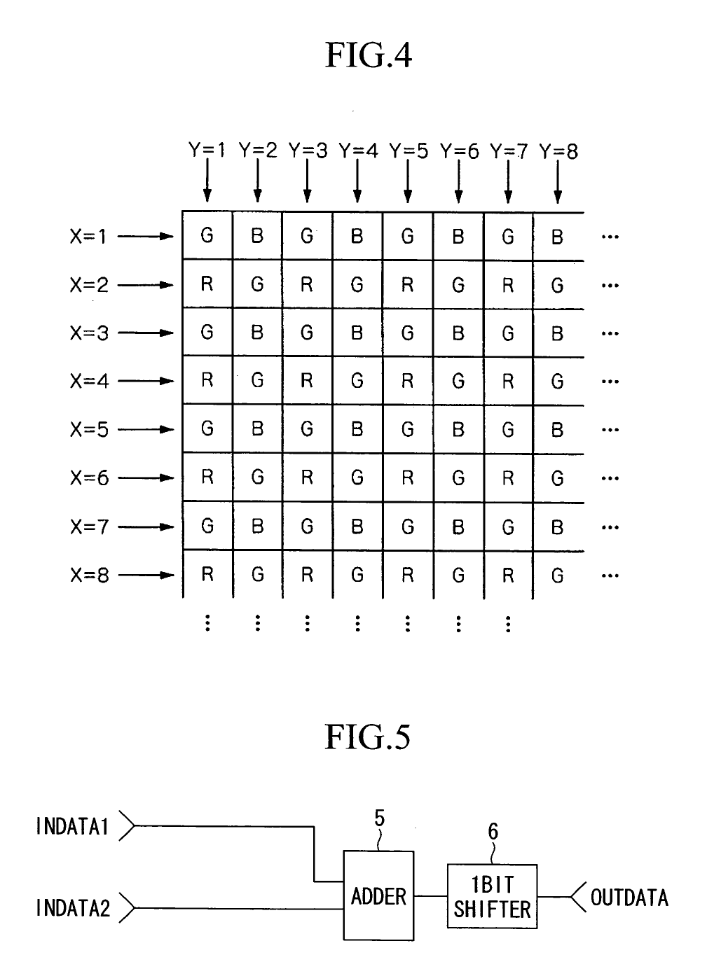

FIG. 4 schematically shows the photo receiving surface, i.e., a plurality of pixels in a matrix form, of the solid-state image sensing device 12, and R, G and B in this figure show pixels which receive light transmitted through the respective color elements of the color filter 11 in which the color elements of the primary colors are arranged in a Bayer pattern (FIG. 2A). The following definitions are used in order to facilitate the following explanation. The coordinate of the pixel which is marked “G” at the upper left corner in this figure is (1, 1). A pixel which positioned along X in the vertical direction and Y in the horizontal direction (coordinates (X, Y)) is called a pixel (X, Y), and the output of the color signal A (A=R, G or B) from the pixel (X, Y) is expressed as A_{XY}.

In this embodiment, from the color signal outputted from the solid-state image sensing device 12 equipped with the color filter 11 of the above-mentioned structure, the luminance signal Y and the color difference signals U and V are generated based on the following principles. That is, the indicator 13 selects or determines that the luminance signal Y and the color difference signals U and V are to be generated for the pixels from which a green (G) color signal is outputted (i.e., pixels marked “G” in FIG. 4).

The interpolator 14 regards the pixel (2, 2) at the coordinates (2, 2) in FIG. 4 as an objective pixel, and determines an interpolated color signal R₂₂ in the objective pixel by using color signals R₂₁ and R₂₃ of a peripheral pixel (2, 1) and a peripheral pixel (2, 3), respectively, which are located adjacent to the objective pixel (2, 2) in the column direction and associated with red color filter elements (marked “R” in FIG. 4). Similarly, an interpolated blue color signal B₂₂ of the objective pixel (2, 2) is determined by using color signals B₁₂ and B₃₂ of a peripheral pixel (1, 2) and a peripheral pixel (3, 2), respectively, which are located adjacent to the objective pixel (2, 2) in the row direction and associated with blue color filter element (marked “B” in FIG. 4).

The luminance color difference signal generator 15 generates the luminance signal Y₂₂ and the color difference signal V₂₂ using the color signal G₂₂ of the objective pixel (2, 2) generated by the sensing device 12, and the interpolated color signals R₂₂ and B₂₂ of the objective pixel (2, 2) generated by the interpolator 14. The operations to generate the luminance signal Y₂₂ and the color difference signal V₂₂ performed by the interpolator 14 and the luminance color difference signal generator 15 are expressed by the following formulas (2) using the color signals R₂₁, R₂₃, G₂₂, B₁₂ and B₃₂ mentioned above.
Y₂₂=0.30 (R₂₁+R₂₃)/2+0.59G₂₂+0.11(B₁₂+B₃₂)/2
V₂₂=−0.30(R₂₁+R₂₃)/2−0.59G₂₂+0.89(B₁₂+B₃₂)/2 Formulas (2)

In formulas (2), (R₂₁+R₂₃)/2, G₂₂, and (B₁₂+B₃₂)/2 are equivalent to the values of the color signals R₂₂, G₂₂, and B₂₂ of the objective pixel (2, 2), respectively. These values are outputted from the interpolator 14. Moreover, the luminance signal Y₂₂ and the color difference signal V₂₂ serve as an output from the luminance color difference signal generator 15.

Here, for the sake of understanding, the formulas (2) express a series of operations by the interpolator 14 and the luminance color difference signal generator 15. However, if the color signal outputs R₂₂, G₂₂, and B₂₂ are temporally stored in the interpolator 14, the luminance color difference signal generator 15 may use the stored values to generate the luminance signal Y and the color difference signals U and V.

Hereafter, a series of operations performed by the interpolator 14 and the luminance color difference signal generator 15 similar to that of formulas (2) is described.

The interpolator 14 determines an interpolated color signal R₃₃ of an objective pixel (3, 3) using color signals R₂₃ and R₄₃ of peripheral pixels (2, 3) and (4, 3), respectively, and determines an interpolated color signal B₃₃ of the objective pixel (3, 3) using color signals B₃₂ and B₃₄ of peripheral pixels (3, 2) and (3, 4), respectively. The luminance color difference signal generator 15 generates a luminance signal Y₃₃ and a color difference signal U₃₃ for the objective pixel (3, 3) using the color signal G₃₃ of the objective pixel generated by the sensing device 12, and the interpolated color signals R₃₃ and B₃₃ determined above. The operations to generate the luminance signal Y₃₃ and the color difference signal U₃₃ are expressed by the following formulas (3) using the above mentioned color signals R₂₃, R₄₃, G₃₃, B₃₂ and B₃₄:
Y₃₃=0.30(R₂₃+R₄₃)/2+0.59G₃₃+0.11(B₃₂+B₃₄)/2
U₃₃=0.70(R₂₃+R₄₃)/2−0.59G₃₃−0.11(B₃₂+B₃₄)/2 Formulas (3)

In formulas (3), (R₂₃+R₄₃)/2, G₃₃, and (B₃₂+B₃₄)/2 are equivalent to the values of the color signals R₃₃, G₃₃, and B₃₃ of the objective pixel (3, 3), respectively. Thus, the luminance signal Y and the color difference signal U or V are generated for all of the pixels marked “G” in FIG. 4 by regarding them as the objective pixels. The luminance signal Y and the color difference signals U and V can be thus generated with respect to the color signals outputted from the solid-state image sensing device 12.

As apparent from the above-mentioned embodiment, for all of the objective pixels marked “G”, the luminance signal Y and the color difference signal U are generated when the objective pixels G are positioned in an odd column (X is an odd number) while the luminance signal Y and the color difference signal V are generated when the objective pixels are positioned in an even column (X is an even number). For this reason, the amount of data of the luminance signals and the color difference signals is the same as that of the color signals outputted from the solid-state image sensing device 12. Additionally, the luminance and color difference signal generator 15 generates the luminance signal Y and the color difference signals U and V at a rate of 2:1:1 which is generally regarded as an optimum rate to minimize the degradation in quality of the image when it is compressed by JPEG That is, compared with the conventional method for generating the luminance signals Y and the color difference signals U and V after performing interpolation for every pixel of the color signal, this embodiment results in one third of the amount of processing as well as the amount of data.

As mentioned above, the color signal G, which includes comparatively much luminance information, directly outputted from the solid-state image sensing device 12 can be used as it is as the color signal to generate the luminance and the color difference signals by making the pixels to which the green color element filter is associated the objective pixels. Generally, the luminance signal, rather than the color difference signal, is closely related to the factor of degradation in the image quality. For this reason, the accuracy of the luminance signal Y becomes higher when it is produced by directly using the color signals outputted by the solid-state image sensing device 12 as they are rather than by using the interpolated color signals. Therefore, degradation in the quality of image caused by the reduction of number of data can be minimized.

Moreover, the color signals R and B in the same coordinates as the objective pixel can be determined by a comparatively simple operation or calculation due to the characteristic of the color filter having the color element arrangement of a Bayer pattern. This calculation can be realized with a circuit only including an adder 5 and 1-bit shifter 6, as shown in FIG. 5. For example, when the interpolated color signal R₂₂ is needed, the color signal R₂, and R₂₃ are supplied to input terminals INDATA1 and INDATA2, respectively. When the interpolated color signal B₂₂ is needed, the color signals B₁₂ and B₃₂ are supplied to the input terminals INDATA1 and INDATA2, respectively.

In the above embodiment, the interpolated color signals R and B at the objective pixel are generated by using the two peripheral pixels, respectively, having the desired color. However, not only two peripheral pixels but more than two circumference pixels can be used for this generation by performing weighting arrangement based on the positional information of the circumference pixels to be used. Moreover, in the above-mentioned embodiment, the luminance signal Y and the color difference signals U and V are generated by setting the pixels corresponding the color element of G as the objective pixels using formulas (2) and (3). In order to control the number of data, it is possible to arbitrarily generate all of the luminance signal Y and the color difference signals U and V or only the luminance signal Y.

For example, operations which make the pixel (2, 2) in FIG. 4 an objective pixel and generate the luminance signal Y₂₂ and the color difference signals U₂₂ and V₂₂ for the objective pixel (2, 2) are represented by the following formulas (4) using the color signals R₂₁ and R₂₃ of the peripheral pixels (2, 1) and (2, 3) in FIG. 4, and the color signal G₂₂ of the objective pixel (2, 2) and the color signals B₁₂ and B₃₂ of the peripheral pixels (1, 2) and (3, 2):
Y₂₂=0.30(R₂₁+R₂₃)/2+0.59G₂₂+0.11(B₁₂+B₃₂)/2
U₂₂=0.70(R₂₁+R₂₃)/2−0.59G₂₂−0.11(B₁₂+B₃₂)/2
V₂₂=−0.30(R₂₁+R₂₃)/2−0.59G₂₂+0.89(B₁₂+B₃₂)/2 Formulas (4)

Furthermore, in the above-mentioned embodiment, all of the pixels having the green (G) color element are determined to be the objective pixels to generate the luminance signal Y and the color difference signals U and V. On the other hand, the pixels associated with the red (R) color elements and the blue (B) color elements or only the pixels associated with the red color elements can be made the objective pixels. That is, it is possible to arbitrarily select the color element for the objective pixels among the outputs of the solid-state image sensing device 12.

For example, when the pixels having the red and blue color elements are selected as the objective pixels, the operations which generate the luminance signal Y and the color difference signals U and V for the objective pixel (2, 3) of R in FIG. 4 and the objective pixel (3, 2) of B are represented by the following formulas (5) and (6), respectively.
Y₂₃=0.30R₂₃+0.59(G₁₃+G₂₂+G₂₄+G₃₃)/4+0.11(B₁₂+B₁₄+B₃₂+B₃₄)/4
U₂₃=0.70R₂₃−0.59(G₁₃+G₂₂+G₂₄+G₃₃)4−0.11(B₁₂+B₁₄+B₃₂+B₃₄)/4 Formulas (5)
Y₃₂=0.30(R₂₁+R₂₃+R₄₁+R₄₃)/4+0.11(G₂₂+G₃₁+G₃₃+G₄₂)/4+0.11 B₃₂
V₃₂=−0.30(R₂₁+R₂₃+R₄₁+R₄₃)/4−0.59(G₂₂+G₃₁+G₃₃+G₄₂)/4+0.89B₃₂ Formulas (6)

In formulas (5), R₂₃, (G₁₃+G₂₂+G₂₄+G₃₃)/4, and (B₁₂+B₁₄+B₃₂+B₃₄)/4 are equivalent to the values of the color signals R₂₃, and the interpolated color signals G₂₃, and B₂₃ in the objective pixel (2, 3), respectively. In formulas (6), (R₂₁+R₂₃+R₄₁+R₄₃)/4, (G₂₂+G₃₁+G₃₃+G₄₂)/4, and B₃₂ are equivalent to the values of the interpolated color signals R₃₂, G₃₂, and the color signal B₃₂ in the objective pixel (3, 2), respectively.

Thus, the luminance signal Y and the color difference signal U or V are generated by making all the pixels associated with the color elements of R and B the objective pixels and thus the luminance signal Y and the color difference signals U and V can be generated for the color signals outputted from the solid-state image sensing device 12.

According to the above, the luminance signal Y and the color difference signal U are generated when the objective pixels are the pixels associated with red (R) color elements of the color filter while the luminance signal Y and the color difference signal V are generated when the objective pixels are the pixels associated with the blue (B) color elements. Similar to when the objective pixels are selected as those associated with G color elements, the amount of data of the luminance signals and the color difference signals is the same as that of the color signals outputted from the solid-state image sensing device 12 in which the luminance signal Y and the color difference signals U and V are generated at a rate of 2:1:1.

Further, the interpolation processing is carried out using the objective pixels of R, which have relatively strong relationship to the color difference signal U, when generating the color difference signal U, and using the objective pixels of B, which have relatively strong relationship to the color difference signal V, when generating the color difference signal V. For this reason, the signals outputted from the image sensing device 12 can be used as they are. Therefore, degradation in quality of the image can be decreased compared with using the objective pixels of G for the image which tends to be influenced more by color information than luminance information.

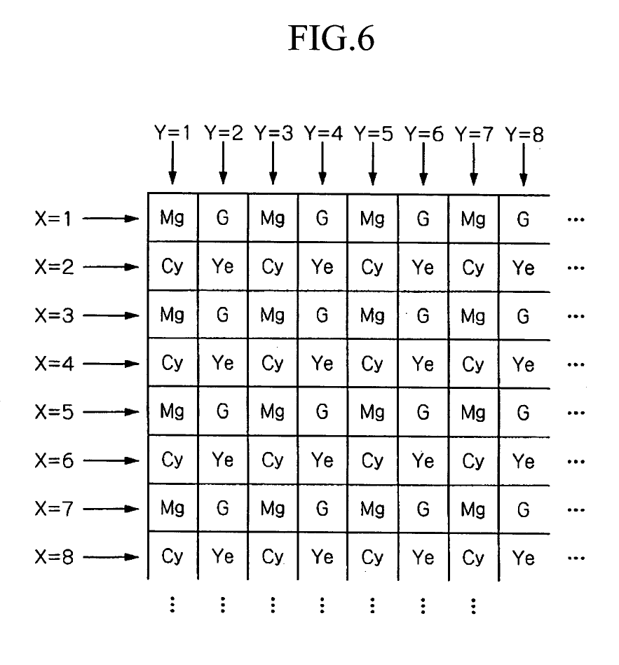

In addition, when the complementary filter shown in FIG. 2B is used instead of the primary color filter as the color filter 11, the luminance signal Y and the color difference signals U and V can be generated using color signals obtained from the pixels shown by Cy, Mg, Ye, and G of the complementary filter as shown in FIG. 6 in a similar manner to that described above.

The luminance signal Y and the color difference signals U and V are thus generated by the pre-processing unit 1 based on the color signals outputted from a solid-state image sensing device 12. The image data compression unit 2 performs the compression processing on the luminance signal Y and the color difference signals U and V. The pre-processing unit 1 does not need a conventional interpolation processor which carries out interpolation processing for every pixel and generates image signals because the interpolator 14 performs the interpolation processing only on the pixel having a specific color element (i.e., on the objective pixel) based on the color signals outputted from the solid-state image sensing device 12. Therefore, since the amount of data outputted from the pre-processing unit 1 is reduced, the period of time required for the compression processing can be also reduced. Moreover, power-saving is realizable in the process for carrying out the compression processing of the color signal outputted from the solid-state image sensing device 12.

Next, the operation of the post-processing unit 4 in which the processing corresponding to the indicator 13, the interpolator 14 and the luminance and color difference signal generator 15 is performed will be explained in detail.

The post-processing unit 4 includes the image signal generator 41 and the color signal generator 42 to generate the image signal from the luminance signal Y and the color difference signals U and V which are previously subjected to the decompression processing by the image data expansion unit 3.

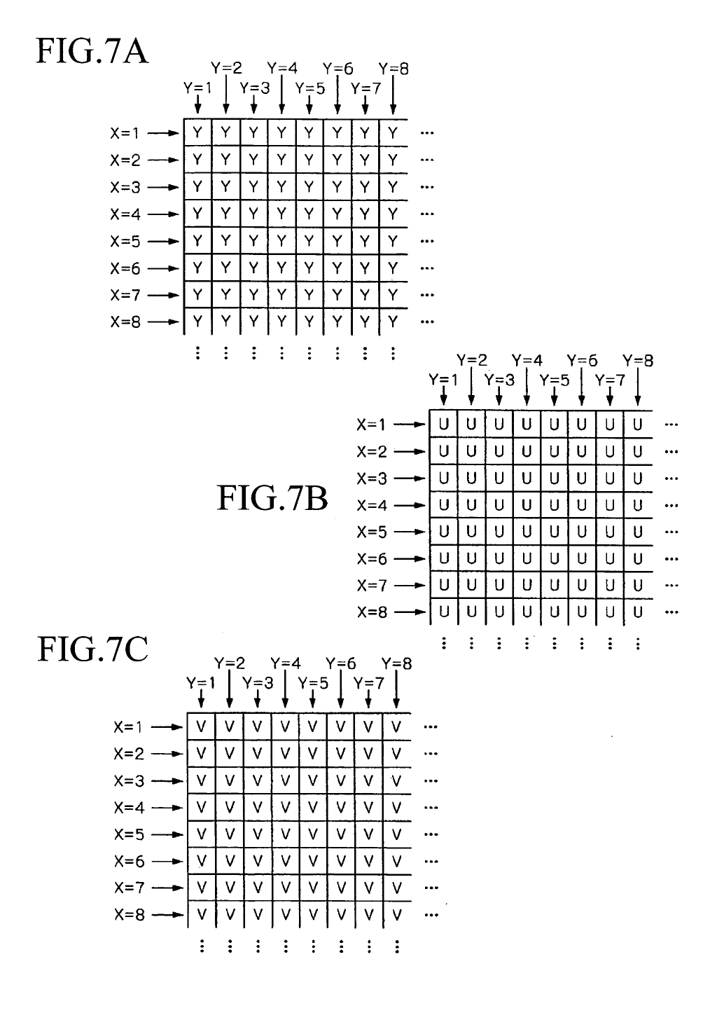

Based on the luminance signal Y and the color difference signals U and V outputted from the image data expansion unit 3, the image signal generator 41 carries out the interpolation processing correspond to the operations by the indicator 13, the interpolator 14, and the luminance and color difference signal generator 15, and generates an image signal as shown in FIGS. 7A, 7B and 7C. Here, in order to facilitate the explanation, the same definition used in reference to the primary color filter shown in FIG. 4 is also applied to FIGS. 7A, 7B and 7C.

The luminance signal Y and the color difference signals U and V outputted from the image data expansion unit 3 can be used as they are to generate the image signal. However, the amount of the luminance signal Y is one half, and the amount of the color difference signals U and V are one fourth the amount of data shown in FIGS. 7A, 7B and 7C. That is, the amount of data of the signal outputted from the image data expansion unit 3 becomes smaller for the resolution of the image signal which should be generated with the color signals outputted from the solid-state image sensing device 12.

Then, it is necessary to interpolate the missing data from the luminance signal Y and the color difference signals U and V outputted from the image data expansion unit 3. For example, luminance signals Y₂₂, Y₂₃, Y₃₂, and Y₃₃, the color difference signals U₂₂, U₂₃, U₃₂, and U₃₃, and V₂₂, V₂₃, V₃₂ and V₃₃ for the pixels (2, 2), (2, 3), (3, 2) and (3, 3) are represented by the following formulas (7) in which the luminance signals Y₂₂ and Y₃₃ and the color difference signals U₃₃ and V₂₂ are generated by the formulas (2) and (3) in the image data expansion unit 3, and the luminance signal Y the color difference signals U and V are similarly generated for other pixels:
Y₂₂=Y₂₂
U₂₂(U₁₁+U₁₃+U₃₁+U₃₃)/4
V₂₂=V₂₂
Y₂₃=(Y₁₃+Y₂₂+Y₂₄+Y₃₃)/4
U₂₃=(U₁₃+U₃₃)/2
V₂₃=(V₂₂+V₂₄)/2
Y₃₂=(Y₂₂+Y₃₁+Y₃₃+Y₄₂)/4
U₃₂=(U₃₁+U₃₃)/2
V₃₂=(V₂₂+V₄₂)/2
Y₃₃=Y₃₃
U₃₃=U₃₃
V₃₃=(V₂₂+V₂₄+V₄₂+V₄₄)/4 Formulas (7)

Thus, the image signal of the YUV space which is one form of an image signal as shown in FIGS. 7A, 7B and 7C is generated by performing the interpolation processing which interpolates missing data from the luminance signal Y and the color difference signals U and V outputted from the image data expansion unit 3.

On the image signal shown in FIGS. 7A, 7B and 7C outputted from the image signal generator 41, the color signal generator 42 performs the color space conversion, and generates the color signals R, G and B.

Generally, the calculation to obtain the color signals R, G and B from the luminance signal Y and the color difference signals U and V is the inverse operation of formulas (1), and is represented by the following formulas (8).
R=Y+U
G=Y−0.51U−0.19V
B=Y+V Formulas (8)

The operations represented by formulas (8) are performed for each pixel for each of the luminance signal Y and the color difference signals U and V outputted from the image signal generator 41 and the image signal of the RGB space which is one form of an image signal generated. The image signal thus generated is reproduced as a picture by an external apparatus, such as a picture playback apparatus.

The post-processing unit 4 shown in FIG. 1 produces the image signal by transmitting the image in YUV space into the image signal of RGB space. However, the image signal of the YUV space outputted from the image signal generator 41 may be treated as an image signal as it is in order to reproduce a picture with a picture playback apparatus, etc. Namely, the post-processing unit 4 may produce the image signal in an appropriate form to correspond to the output format which the external apparatus requires. Therefore, the post-processing unit 4 can also be called a format conversion unit.

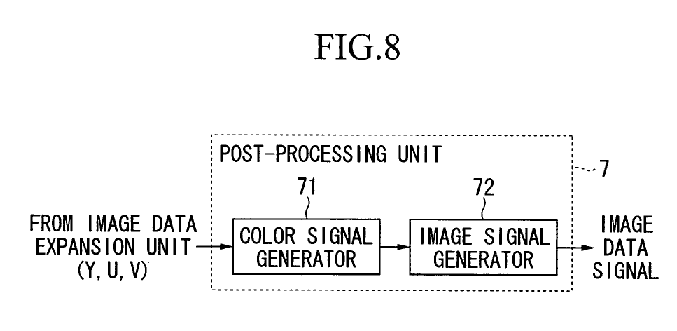

In the above-mentioned post-processing unit 4, the image signal generator 41 generates the image signal of the YUV space based on the luminance signal Y and the color difference signals U and V, and the color signal generator 42 generates the image signal of the RGB space which is one form of an image signal. As shown in FIG. 8, the post-processing unit 7 may alternatively be constituted such that the arrangement of the image signal generator and the color signal generator are reversed.

In the post-processing unit 7 thus constituted, a color signal generator 71 generates the color signals R, G and B arranged in a Bayer pattern as shown in FIG. 4 using the luminance signal Y and the color difference signals U and V outputted from the image data expansion unit 3. Subsequently, an image signal generator 72 performs interpolation processing which interpolates missing data of the color signals R, G and B arranged in a Bayer pattern outputted from the color signal generator 71, and generates the image signal of RGB space. The image signal thus generated is reproduced as a picture with s picture playback apparatus, etc. similar to the image signal from the post-processing unit 4.

### Second Embodiment

Next, a second embodiment of the present invention will be explained.

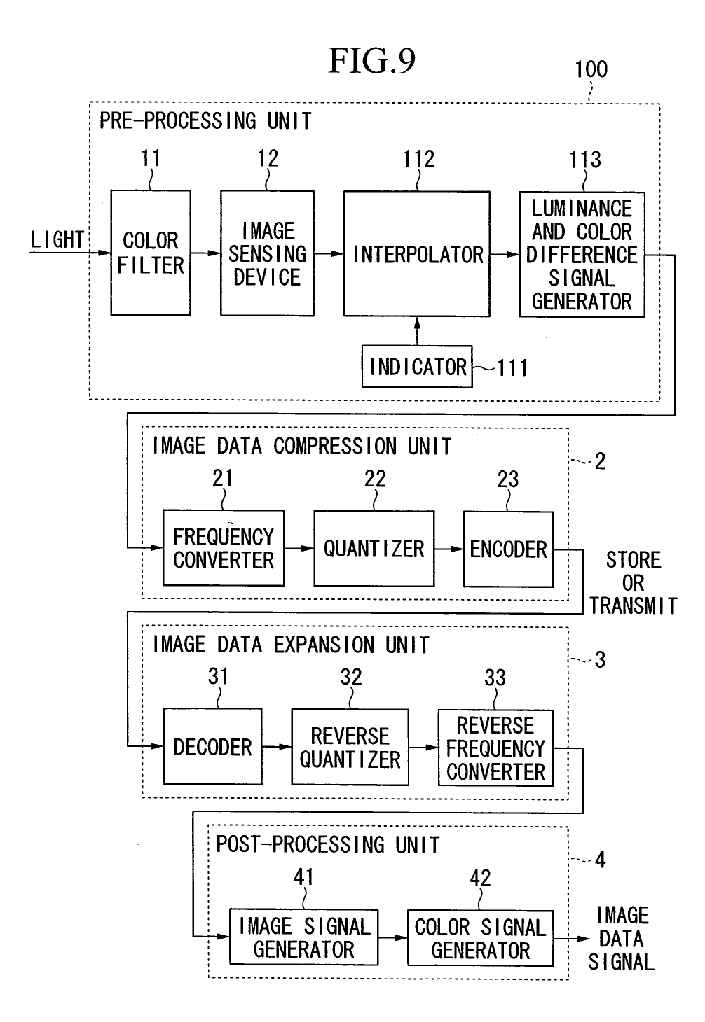

FIG. 9 is a block diagram showing an image processing system according to the second embodiment of the present invention. Structural elements similar to or the same as the first embodiment bear the same reference numerals and explanations thereof are omitted.

In the second embodiment, the difference from the first embodiment is in the operations of an objective pixel indicator 111, the interpolator 112 and a luminance and color difference signal generator 113 contained in a pre-processing unit 100.

More specifically, the objective pixel indicator 111 makes the luminance and color difference signal generator 113 generate the luminance signal and/or the color difference signals for all the pixels associated with the color element filter of green, red and blue in a solid-state image sensing device 12 as the objective pixels.

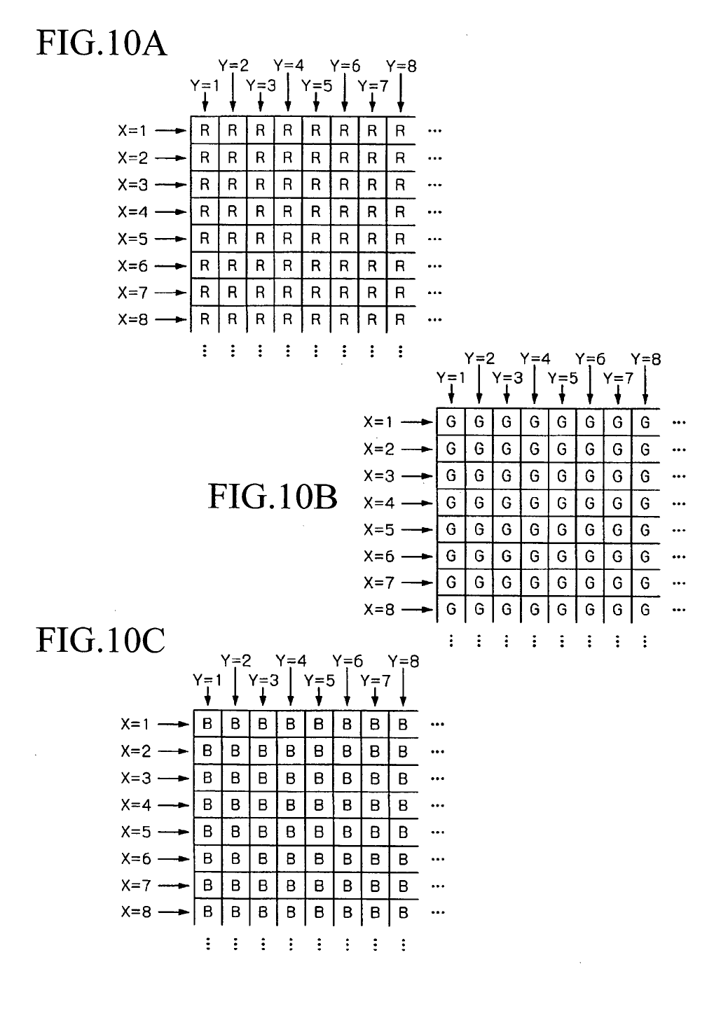

In response to the setup of the indicator 111, the interpolator 112 performs interpolation processing based on the color signal outputted from the solid-state image sensing device 12, and generates color signals shown in FIGS. 10A, 10B and 10C. In order to make the explanation hereinafter easy to understand, the same definitions used for the primary color filter in reference to FIG. 4 are also applied to FIGS. 10A, 10B and 10C.

For example, the operations of generating the red color signals R₂₂, R₂₃, R₃₂ and R₃₃, the green color signals G₂₂, G₂₃, G₃₂, and G₃₃, and the blue color signals B₂₂, B₂₃, B₃₂, and B₃₃ of the pixels (2, 2), (2, 3), (3, 2), and (3, 3), respectively, in FIGS. 10A, 10B and 10C are represented by the following formulas (9), similar to in the explanation with reference to FIG. 4, using the color signals R, G and B of the peripheral pixels.
R₂₂=(R₂₁+R₂₃)/2
G₂₂=G₂₂
B₂₂=(B₁₂+B₃₂)/2
R₂₃=R₂₃
G₂₃=(G₁₃+G₂₂+G₂₄+G₃₃)/4
B₂₃=(B₁₂+B₁₄+B₃₂+B₃₄)/4
R₃₂=(R₂₁+R₂₃+R₄₁+R₄₃)/4
G₃₂=(G₂₂+G₃₁+G₃₃+G₄₂)/4
B₃₂=B₃₂
R₃₃=(R₂₃+R₄₃)/2
G₃₃=G₃₃
B₃₃=(B₃₂+B₃₄)/2 Formulas (9)

Thus, the image signal of the RGB space which is one form of an image signal is generable by carrying out interpolation processing of the missing data for every color based on the color signal outputted from the solid-state image sensing device 12.

From the image signal outputted from the interpolator 112, the luminance and color difference signal generator 113 in this embodiment generates the luminance signal Y and the color difference signals U and V based on the following principles, and outputs them to the image data compression unit 2. That is, the luminance signal Y₂₂ is determined by using the color signal G₂₂ of the pixel (2, 2) associated with the color filter G in FIG. 10B, and the interpolated color signals R₂₂ and B₂₂ of the pixel (2, 2) in FIGS. 10A and 10C. Then, the color difference signal U₂₃ is determined by using the color signal R₂₃ of a pixel (2, 3) associated with the color filter R in FIG. 10A, and the interpolated color signals G₂₃ and B₂₃ of the pixel (2, 3) in FIGS. 10B and 10C. Furthermore, the color difference signal V₃₂ is determined by using the color signal B₃₂ of a pixel (3, 2) associated with the color filter B in FIG. 10C, and the interpolated color signals R₃₂ and G₃₂ of the pixel (3, 2) in FIGS. 10A and 10B. The operations which generate the luminance signal Y₂₂ and the color difference signals U₂₃ and V₃₂ are represented by the following formulas (10) using the color signals R, G and B mentioned above.
Y₂₂=0.30R₂₂+0.59G₂₂+0.11B₂₂
U₂₃=0.70R₂₃−0.59G₂₃=0.11B₂₃
V₃₂=−0.30R₃₂−0.59G₃₂+0.89B₃₂ Formula (10)

Thus, the luminance signal Y and the color difference signal U or V are generated based on the image signal at the same coordinates outputted from the interpolator 112 and, thus, the luminance signal Y and the color difference signals U and V can be generated for the color signal outputted from the solid-state image sensing device 12.

According to the above, the luminance signal Y is generated corresponding to the pixel associated with the color element G of the color filter, the color difference signal U is generated corresponding to the pixel associated with the color element R and the color difference signal V is generated corresponding to the pixel associated with the color element B based on the color signal outputted by the solid-state image sensing device 12. Therefore, the amount of data of the luminance signals and the color difference signals is the same as that of the color signals outputted from the solid-state image sensing device 12. Further, the luminance signal Y and the color difference signals U and V are generated at a rate of 2:1:1 which is generally regarded as an optimum rate to minimize the degradation in quality of the image when compressed by JPEG

As mentioned above, the luminance signal Y is generated by using the pixel associated with the color element G, the color difference signal U is generated by using the pixel associated with the color element R, and the color difference signal V is generated by using the pixel associated with the color element B. Therefore, those signals outputted from the image sensing device 12 can be used as they are. As apparent from formulas (1), the luminance signal Y has a relatively strong relationship to the color signal G, the color difference signal U has a relatively strong relationship to the color signal R, and the color difference signal V has a relatively strong relationship to the color signal B. For this reason, the accuracy of the luminance signal Y and the color difference signals U and V is higher when they are produced by directly using the color signals outputted by the solid-state image sensing device 12 as they are than when using the interpolated color signals. Therefore, degradation in the quality of image caused by the reduction of the amount of data can be minimized.

In the above explanation, the luminance signal Y is generated corresponding to the pixel associated with the color element G of the color filter, the color difference signal U is generated corresponding to the pixel associated with the color element R, and the color difference signal V is generated corresponding to the pixel associated with the color element B based on the color signal outputted by the solid-state image sensing device 12. However, the correspondence between the color signals and the generated luminance and color difference signals may be changed to improve the quality of the image and to simplify the calculations.

Moreover, in the above explanation, each color of the color signal outputted from the solid-state image sensing device 12 and one of the luminance signal Y and the color difference signal U and V has an one to one correspondence. However, two or more of the luminance signal Y and the color difference signal U and V may be generated by using one of the color signals R, G and B. For example, the luminance signal Y and the color difference signal U may be generated by using only the color signal G outputted from the solid-state image sensing device 12.

According to the structure of the pre-processing unit 100, the luminance signal Y and the color difference signals U and V are generated based on the color signal outputted from a solid-state image sensing device 12. The image data compression unit 2 performs compression processing on the luminance signal Y and the color difference signals U and V thus generated. Therefore, since the amount of data outputted from the pre-processing unit 100 is reduced, the period of time required for the compression processing can be also reduced. Moreover, power-saving is realizable in the process for carrying out the compression processing of the color signal outputted from the solid-state image sensing device 12.

### Third Embodiment

Next, a third embodiment of the present invention will be explained.

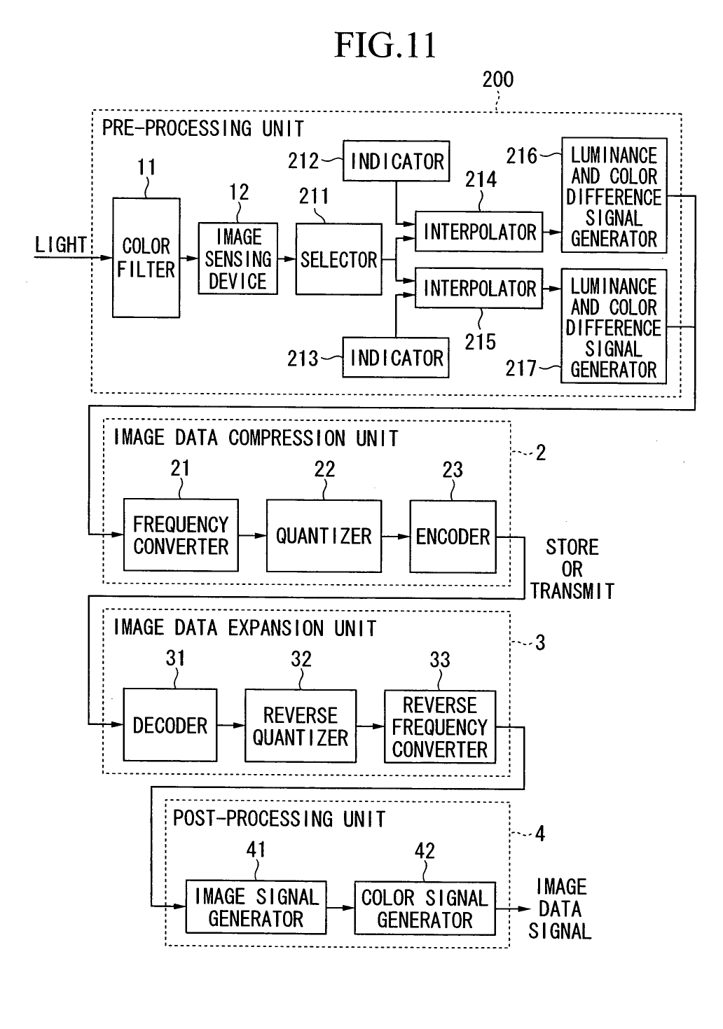

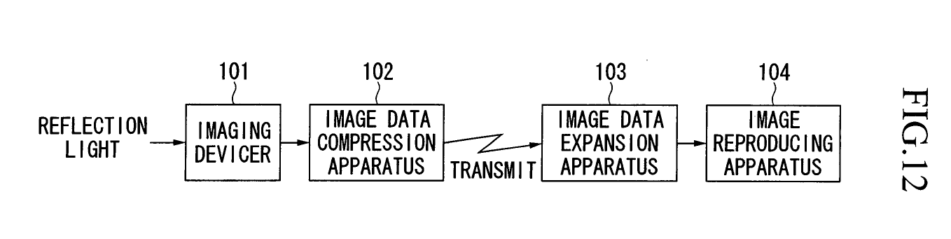

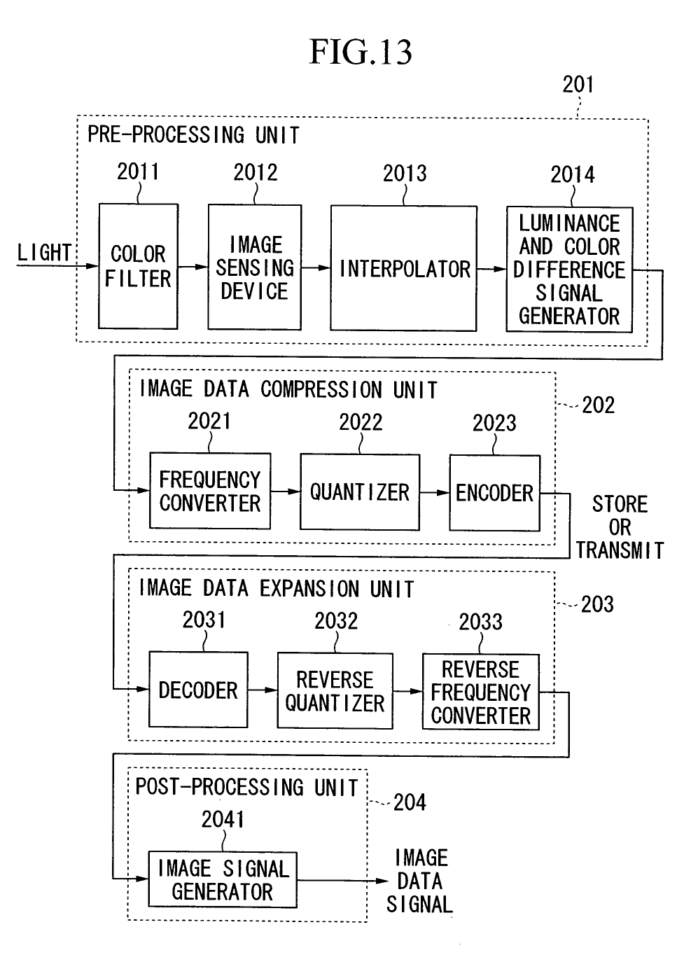

FIG. 11 is a block diagram showing an image processing system according to the third embodiment of the present invention. Structural elements similar to or the same as the first and second embodiments bear the same reference numerals and the explanations thereof are omitted.

In the third embodiment, the difference from the first and second embodiments is in the operations of a selector 211, a pair of objective pixel indicators 212 and 213, a pair of interpolators 214 and 215, and a pair of luminance and color difference signal generators 216 and 217 in a pre-processing unit 200.

The selector 211 receives the color signal outputted from the solid-state image sensing device 12 corresponding to the color element arrangement of the color filer 11 and selects one of the interpolators 214 and 215 to which the color signal is to be supplied based on the usage of the system such as obtaining a high density image or operating in power saving. The indicator 212 indicates to the interpolator 214 of the operation of generating the luminance signal and the color difference signal for the pixels in even columns in the photosensitive matrix of the solid-state image sensing device 12.

Based on the color signal outputted from the selector 211, the interpolator 214 and the luminance and color difference signal generators 216 generate the luminance signal Y and the color difference signals U and V on the following principles, and output them to the image data compression unit 2.

Specifically, the interpolator 214 sets the pixels positioned in the even columns in FIG. 4 (X is even number) as the objective pixels and generates the missing data of the color signals R, G and B in the positions by interpolation processing. The luminance and color difference signal generator 216 generates the luminance signal Y and the color difference signals U and V using the color signal outputted from the solid-state image sensing device 12 and the interpolated color signals R, G and B from the interpolator 214.

For example, the operations for generating the luminance signals Y₂₂ and Y₂₃ and the color difference signals V₂₂ and U₂₃ for the objective pixel (2, 2) associated with the color filter element G (FIG. 4) and the objective pixel (2, 3) associated with the color filter element R (FIG. 4) are represented by the following formulas (11), using the red color signals R₂, and R₂₃, the green color signals G₁₃, G₂₂, G₂₄ and G₃₃, and the blue color signals B₁₂, B₁₄, B₃₂ and B₃₄ of the peripheral pixels (2, 3), (1, 3), (2, 2), (2, 4), (3, 3), (1,2), (1,4), (3,2), and (3,4):
Y₂₂=0.30(R₂₁+R₂₃)/2+0.59G₂₂+0.11(B₁₂+B₃₂)/2
V₂₂==0.30(R₂₁+R₂₃)/2−0.59G₂₂+0.89(B₁₂+B₃₂)/2
Y₂₃=0.30R₂₃+0.59(G₁₃+G₂₂+G₂₄+G₃₃)/4+0.11(B₁₂+B₁₄+B₃₂+B₃₄)/4
U₂₃=0.70R₂₃−0.59(G₁₃+G₂₂+G₂₄+G₃₃)/4−0.11(B₁₂+B₁₄+B₃₂+B₃₄)/4 Formulas (11)

In formula (11), (R₂₁+R₂₃)/2, G₂₂, and (B₁₂+B₃₂)/2 are values equivalent to the color signals R₂₂, G₂₂ and B₂₂ of the objective pixel (2, 2), while R₂₃, (G₁₃+G₂₂+G₂₄+G₃₃)/4, and (B₁₂+B₁₄+B₃₂+B₃₄)/4 are values equivalent to the color signals R₂₃, G₂₃ and B₂₃ of the objective pixel (2, 3), respectively, which are outputted from the interpolator 214.

Moreover, the luminance signals Y₂₂ and Y₂₃ and the color difference signals U₂₃ and V₂₂ serve as an output from the luminance and the color difference signal generator 216.

Thus, only in the even columns in FIG. 4, interpolation processing of the lacked data for every color signal is carried out, and the luminance signal Y and the color difference signal U or V are generated for each pixel in the even columns. Thus, the luminance signal Y and the color difference signals U and V are generable for the color signal outputted from the solid-state image sensing device 12.

According to the above manner, the luminance signal Y and the color difference signal are generated corresponding to the pixels associated with the color filter element G of the color filter and positioned in the even columns in FIG. 4, while the luminance signal Y and the color difference signal U are generated corresponding to the pixels associated with the color filter element R and positioned in the even columns in FIG. 4 based on the color signal outputted by the solid-state image sensing device 12. Therefore, similar to in the first embodiment, the amount of data of the luminance signals Y and the color difference signals U and V is the same as that of the color signals outputted from the solid-state image sensing device 12. Further, the luminance signal Y and the color difference signals U and V are generated at a rate of 2:1:1 which is generally regarded as an optimum rate to minimize the degradation in quality of the image when compressed by JPEG.

As mentioned above, in the first embodiment, the luminance signal Y and the color difference signals U and V are generated corresponding to the objective pixels associated with the color elements G of the color filter which are arranged in a diagonal line. On the other hand, in this third embodiment, the luminance signal Y and the color difference signals U and V are generated corresponding to the objective pixels arranged in the even columns in FIG. 4. Therefore, the degradation in quality of image can be reduced when the image is compressed in a irreversible compression manner which utilizes the relationships between the peripheral pixels.

In the above explanation, the luminance signal Y and the color difference signals U and V are generated by using the objective pixels located in the even columns (X is an even number) in FIG. 4. It is also possible to generate the luminance signal Y and the color difference signals U and V by using objective pixels located in odd columns (X is an odd number).

In addition, the indicator 213 indicates to the interpolator 215 the operation of generating the luminance signal and the color difference signal for the pixels in even rows in the photosensitive matrix of the solid-state image sensing device 12.

Based on the color signal outputted from the selector 211, the interpolator 215 and the luminance and color difference signal generators 217 generate the luminance signal Y and the color difference signals U and V on the following principles, and output them to the image data compression unit 2.

Namely, the interpolator 215 sets the pixels positioned in the even rows in FIG. 4 (Y is even number) as the objective pixels and generates the missing data of the color signals R, G and B in the positions by interpolation processing. The luminance and color difference signal generator 217 generates the luminance signal Y and the color difference signals U and V using the color signal outputted from the solid-state image sensing device 12 and the interpolated color signals R, G and B from the interpolator 215.

For example, the operations for generating the luminance signals Y₂₂ and Y₃₂ and the color difference signals U₂₂ and V₃₂ for the objective pixel (2, 2) associated with the color filter element G (FIG. 4) and the objective pixel (3, 2) associated with the color filter element B (FIG. 4) are represented by the following formulas (12), using the red color signals R₂₁, R₂₃, R₄₁ and R₄₃, the green color signals G₂₂, G₃₁, G₃₃ and G₄₂, and the blue color signals B₁₂ and B₃₂ of the peripheral pixels (2, 1), (2, 3), (4, 1), (4, 3), (2, 2), (3, 1), (3,3), (4,2), (1,2), and (3,2):
Y₂₂=0.30(R₂₁+R₂₃)/2+0.59G₂₂+0.11(B₁₂+B₃₂)/2
U₂₂=0.30(R₂₁+R₂₃)/2−0.59G₂₂−0.11(B₁₂+B₃₂)/2
Y₃₂=0.30(R₂₁+R₂₃+R₄₁+R₄₃)/4+0.59(G₃₁+G₂₂+G₄₂+G₃₃)/4+0.11B₃₂
V₃₂=−0.30(R₂₁+R₂₃+R₄₁+R₄₃)/4−0.59(G₃₁+G₂₂+G₄₂+G₃₃)/4+0.89B₃₂ Formula (12)

In formula (12), (R₂₁+R₂₃)/2, G₂₂, and (B₁₂+B₃₂)/2 are values equivalent to the color signals R₂₂, G₂₂ and B₂₂ of the objective pixel (2, 2), while (R₂₁+R₂₃+R₄₁+R₄₃)/4, (G₃₁+G₂₂+G₄₂+G₃₃)/4, and B₃₂ are values equivalent to the color signals R₃₂, G₃₂ and B₃₂ of the objective pixel (3, 2), respectively, which are outputted from the interpolator 215.

Moreover, the luminance signals Y₂₂ and Y₃₂ and the color difference signals U₂₂ and V₃₂ serve as an output from the luminance and the color difference signal generator 217.

Thus, only in the even rows in FIG. 4, interpolation processing of the missing data for every color signal is carried out, and the luminance signal Y and the color difference signal U or V are generated for each pixel in the even rows. Thus, similar to the luminance and color difference signal generator 216, the luminance signal Y and the color difference signals U and V are generable for the color signal outputted from the solid-state image sensing device 12 and the degradation in quality of image can be reduced.

The luminance signal Y and the color difference signals U and V are thus generated by the pre-processing unit 200 based on the color signals outputted from a solid-state image sensing device 12. The image data compression unit 2 performs the compression processing on the luminance signal Y and the color difference signals U and V. As in the first embodiment, the pre-processing unit 200 does not need a conventional interpolation processor which carries out interpolation processing for every pixel to generate image signals. Therefore, since the amount of data outputted from the pre-processing unit 200 is reduced, the period of time required for the compression processing can be also reduced. Moreover, power-saving is realizable in the process for carrying out the compression processing of the color signal outputted from the solid-state image sensing device 12.

Moreover, according to the above-mentioned pre-processing unit 200, one of the interpolators 214 and 215 which interpolate the color signal outputted from the solid-state image sensing device 12 can be selected by the selector 211. For example, the interpolator 214 is chosen when the color signal has comparatively many horizontal components, and the interpolator 215 is chosen when the color signal has many vertical components. The degradation in quality of image can be reduced by selecting the interpolator appropriate to the features of the color signal.

As described above, the present invention realizes a luminance and color difference signal generation apparatus capable of carrying out the image data compression with deducted amount of data and saved electric power consumption. The present invention, therefore, achieves power-saved and compact luminance and color difference signal generation apparatus and image data compression apparatus.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A luminance and color difference signal generation apparatus for generating a luminance and color difference signals based on a plurality of initial color signals outputted from a solid-state image sensing device equipped with a color filter having a plurality of color elements arranged in a predetermined pattern on a photo sensitive surface having a plurality of pixels arranged in a matrix form, comprising:
an objective pixel indicator which determines an objective pixel from said plurality of pixels of said solid-state image sensing device;
an interpolation processor which generates color signals of said objective pixel according to an interpolation calculation, said color signals being indicative of colors different from a color of one of said color elements of said color filter associated with said objective pixel; and
a luminance and color difference signal generator which generates said luminance signal and one of said color difference signals based on a color signal obtained from said objective pixel and said color signals obtained by said interpolation calculation concerning said objective pixel.

2. A luminance and color difference signal generation apparatus as recited in claim 1, wherein said objective pixel indicator determines a pixel associated with a green color element of said color filter from said plurality of pixels of said solid-state image sensing device as said objective pixel.

3. A luminance and color difference signal generation apparatus as recited in claim 1, wherein:
said color filter has said color elements arranged in a Bayer pattern;
said luminance and color difference signal generator generates said luminance signal and a first color difference signal of said color difference signals when said objective pixel is in an odd column in said matrix form of said plurality of pixels; and
said luminance and color difference signal generator generates said luminance signal and a second color difference signal different from said first color difference signal when said objective pixel is in an even column in said matrix form of said plurality of pixels.

4. A luminance and color difference signal generation apparatus for generating a luminance and color difference signals based on a plurality of initial color signals outputted from a solid-state image sensing device equipped with a color filter having a plurality of color elements arranged in a predetermined pattern on a photo sensitive surface having a plurality of pixels arranged in a matrix form, comprising:
an objective pixel indicator which determines an objective pixel from said plurality of pixels of said solid-state image sensing device;
an interpolation processor which generates color signals of said objective pixel according to an interpolation calculation, said color signals being indicative of colors different from a color of one of said color elements of said color filter associated with said objective pixel; and
a luminance and color difference signal generator which generates at least one of said luminance and color difference signals according to said color of said color element associated with said objective pixel and based on a color signal obtained from said objective pixel and said color signals obtained by said interpolation calculation concerning said objective pixel.

5. A luminance and color difference signal generation apparatus as recited in claim 4, wherein said luminance and color difference signal generator generates said luminance signal when said objective pixel is associated with a green color element, generates a first color difference signal of said color difference signals when said objective pixel is associated with a red color element, and generates a second color difference signal different from said first color difference signal of said color difference signals when said objective pixel is associated with a blue color element.

6. A luminance and color difference signal generation apparatus for generating a luminance signal and color difference signals from a plurality of initial color signals outputted from a solid-state image sensing device equipped with a color filter having a plurality of color elements arranged in a predetermined pattern on a photo sensitive surface having a plurality of pixels arranged in a matrix form, comprising:
an interpolation processor which generates color signals of an arbitrary pixel according to an interpolation calculation, said color signals being indicative of color attributes different from a color attribute of one of said color element of said color filter associated with said arbitrary pixel;
a luminance and color difference signal generator which generates at least one of said luminance signal and said color difference signals for said arbitrary pixel based on said color signals concerning said arbitrary pixel; and
an objective pixel indicator which determines pixels in a predetermined column or predetermined row in said matrix form of said plurality of pixels of said solid-state image sensing device as objective pixels for which said luminance signal and/or said color difference signals are generated.

7. A luminance and color difference signal generation apparatus as recited in claim 6, wherein said objective pixel indicator selects said predetermined column or predetermined row according to a certain pattern.

8. A luminance and color difference signal generation apparatus as recited in claim 6, wherein said luminance and color difference signal generator generates a predetermined combination of said luminance signal and said color difference signals in response to said predetermined column or predetermined row.

9. A luminance and color difference signal generation apparatus as recited in claim 6, wherein:
said color filter has said color elements arranged in a Bayer pattern;
said luminance and color difference signal generator generates said luminance signal and a first color difference signal of said color difference signals when said predetermined column is an odd column in said matrix form of said plurality of pixels; and
said luminance and color difference signal generator generates said luminance signal and a second color difference signal different from said first color difference signals when said predetermined column is an even column in said matrix form of said plurality of pixels; or
said luminance and color difference signal generator generates said luminance signal and a first color difference signal of said color difference signals when said predetermined row is an odd row in said matrix form of said plurality of pixels; and
said luminance and color difference signal generator generates said luminance signal and a second color difference signal different from said first color difference signals when said predetermined row is an even row in said matrix form of said plurality of pixels.

10. An image compression apparatus comprising the luminance and color difference signal generation apparatus as recited in claim 1 and an image compression unit including:
a frequency converter which calculates spatial frequency components for each block in each of said luminance signal and said color difference signal generated by said luminance and color difference signal generation apparatus;
a quantizer which quantizes said spatial frequency components; and
an encoder which encodes quantized spatial frequency components quantized by said quantizer.

11. An image processing system comprising:
the image compression apparatus as recited in claim 10;
an image data expansion unit including a decoder which decodes said quantized spatial frequency components quantized from the output of said image compression apparatus, a reverse quantizer which performs reverse-quantization of the decoded spatial frequency components, and a reverse frequency converter which calculates said luminance signal and said color difference signals for each of said block based on the reverse-quantized spatial frequency components; and
a format converter which converts said luminance signal and said color difference signals outputted from said image data expansion unit into an output format required by an external apparatus.

12. An image processing system as recited in claim 11, wherein said format converter includes:
an image signal generator which converts said luminance signal and said color difference signals into said color signals; and
a color signal generator which interpolates color signals for pixels other than said objective pixel to said color signals from said image signal generator.

13. An image processing system as recited in claim 11, wherein said format converter includes:
a luminance and color difference signal interpolator which interpolates a luminance signal and a color difference signal for pixels other than said objective pixel based on said luminance signal and said color difference signal; and
a color signal generator which converts said luminance signal and said color difference signal obtained from said luminance and color difference signal interpolator into said color signals.
